(19) United States
(12) Patent Application Publication
(10) Pub. No.: US 2011/0305539 A1
(43) Pub. Date: Dec. 15, 2011

(54) Protective Cover Adapted For A Visual Aid

(75) Inventor: Robert John Rand, Calgary (CA)

(73) Assignee: Bud-Eze Systems Inc., Calgary (CA)

(21) Appl. No.: 13/118,622

(22) Filed: May 31, 2011

(30) Foreign Application Priority Data
Jun. 10, 2010 (CA) 2707556

(51) Int. Cl. F16B 37/14

(52) U.S. Cl. 411/373; 411/372.5; 411/429

(57) ABSTRACT

A protective cover for a wheel fastening member, said protective cover comprising a body having a top and a bottom, an internal hollow extending from top to bottom and surrounded by an adjacent internal surface and an external surface: the internal surface of the protective cover snugly fitting over the fastening member in use and the external surface comprising flanges to receive a visual aid for indicating the security status of the fastening member, said flanges including a gripping collar and a top collar having a plurality of vertical ribs extending therebetween to restrict the movement of the visual aid, wherein the protective cover protects the fastening member from corrosion and secures the visual aid therewith.

### FIELD OF INVENTION

This invention pertains to protective covers which protect fastening members such as nuts and bolts from the elements such as dust and moisture, and specifically the protective covers are adapted to accommodate a visual aid to indicate the undesirable of the rotation of the fastening member.

### BACKGROUND OF THE INVENTION

There is a tendency for nuts and bolts to become loose due to vibration during normal operation of heavy machinery. This also happens from time to time with the nuts and bolts used to attach vehicle wheels. Since a loose wheel can become a hazard, it is very important to keep the nuts and bolts tightened. There are some developments in the art pertaining to the use of nut indicators to confirm a safe position for the nuts and bolts, for example, the use of “checkpoint” flags. Another problem with wheel attaching nuts and bolts is the susceptibility to dirt, dust and corrosion. There are several solutions in the art for protecting nuts and bolts from corrosion and the elements. Each development has deficiencies and does not address the need for a nut cover adapted for visual aid to indicate the nut position . None of the prior art devices provide a cover capable of accommodating existing flags for wheel nuts.

Visual aids or flags for indicating the position of a nut are well known in the prior art and presented in the following patents: U.S. Pat. No. 6,158,933; U.S. Pat. No. 6,270,302; U.S. Pat. No. 604,155 ; U.S. Pat. No. 610,442. Such visual aids are currently available on the market and are known by their trade names: “Wheel-Check” and “Checkpoint”.

U.S. Pat. No. 388,764 teaches a nut lock which indicates the position of the nut and also prevents its rotation.

U.S. Pat. No. 4,734,001 and U.S. Pat. No. 4,906,150 teach a locking fastener for a bolt or nut preventing the rotation of the bolt or nut. The fastener is attached to the bolt or nut with a locking plate. The use of this invention requires special preparation of the nuts and bolts to receive this locking plate and makes use of this system very expensive.

Canadian Industrial Design 57758 teaches a nut cover for protecting nuts and bolts. This nut cover is not adapted to receive a visual aid, and does not address a means for removal of the cap from the nut.

Canadian Industrial Design 64880 teaches a nut cover for protecting nuts and bolts. This nut cover is not adapted to receive a visual aid available on the market.

U.S. Pat. No. 6,135,691 teaches protective caps for bolts and nuts. However, no attachment for visual aid is provided. Further, there are no means provided to assist in the removal of the cap from the bolts. Therefore, the cap after removal might be destroyed and not suitable for reuse.

U.S. Pat. No. 6,561,124 teaches a position indicator assembly for nuts and/or bolts. This indicator is installed on top of a specially threaded nut or bolt. This technique requires manufacturing of special nuts and bolts to be used with the specific visual aids. This technique is not versatile for simple manufacturing. Addition of the ribs to the body of the nut would substantially increase the cost of this nut. Further, this patent does not teach a protective cap for a fastening member adapted to receive a visual aid.

U.S. Pat. No. 6,595,597 teaches a combined dust cap and position indicating device for vehicle wheel nuts. The dust caps of this patent comprise two parts: body and cover. In one embodiment of the invention, the indicator is attached either to the body or the cap. While in another embodiment of the invention, the indicator is attached to the cover of the cap. The dust cap of the '597 Patent has several deficiencies. First of all it, is made up of two parts, which makes the manufacturing and the storage of the cap more expensive. Further, with the two part cap, it is very difficult to reach positive sealing between the body and the cap, and in this way moisture might enter through the spaces between the parts and cause corrosion of the fastening members. Further, the caps of the '597 Patent do not comprise any means to assist in the removal of the cap. Therefore, in order to remove the cap, a tool such as pliers would have to be used and therefore the cap might be destroyed during this operation. The removal of this type of cap will be difficult since the cap is usually covered with oil and grease and therefore there is a high chance that the cap would be destroyed and discarded every time the tightening of the nut is required. Another issue with this type of dust cap is the ease of removal of the flag extending from the cover. Since there are no means that can prevent the vertical movement of the cover with the flag, it can be accidentally displaced. The displacement can occur during the regular operation of the vehicle which experiences many forces in different directions and also through tampering with the flags. Those deficiencies should be addressed.

Canadian Patent No. 2,448,352 teaches a rotation inhibiting system for adjacent nuts or bolts. This system comprises socket elements mounted on the nuts or bolts and connector elements mounted on top of those socket elements. The connector element also comprises a flag to indicate the position of the nut or bolt. The socket elements of this patent does not protect the nuts or bolts from corrosion since they have no caps. Further these socket elements have no means to assist in their removal. Further the system in the '352 Patent is not fitted to receive visual aids available on the market. Finally this system requires manufacturing of special socket elements and matching connector elements which make this system expensive.

U.S. Pat. No. 7,415,888 teaches a safety device for multiple wheel nuts. The device comprises a position indicator attached to the nut, a ring holder situated on top of the position indicator and a fastener cover fixing the ring holder to the cap. This arrangement has its deficiencies; first it is very cumbersome to maintain this type of the device. In order to tighten one loose nut, the whole device would have to be disassembled including removal of all the caps (about ten), removal of the ring holder, removal of the position indicator and only then tightening of the nut. Then all the parts have to be repositioned in the reverse order. The protective covers of the '888 Patent do not have any means of assisting in their removal therefore there is a high possibility that these covers may become damaged and would require replacement. Further, the protective cap does not have the means for receiving of the visual aids available on the market. The visual aid of the '888 Patent is specifically manufactured to receive the protective cap and not the reverse. Finally, this arrangement is cumbersome to manufacture and operate. Therefore these issues should be addressed.

US Patent Application No. 2009/0060677 teaches a wheel lug nut management device. The device comprises a lug nut cap engaging a nut and indicating its position and a cover protecting the nut from corrosion. This device does not provide a cap protecting a fastening member and also adapted to receive a visual aid available on the market. The structure of this device is complicated and therefore it's manufacturing and use are cumbersome.

There are also products known by the names “Dustite” and “Dustite LR” manufactured by Business Lines Ltd. These products provide a one piece combination of dust cap with integral visual loose nut indicator. But these products are not constructed to receive visual aids available on the market.

Therefore, there is still a need for an inexpensive protective cover for wheel nuts and bolts, adapted to receive known visual aids currently available on the market.

A primary objective of the present invention therefore is to provide a protective cover for nuts and bolts capable of accommodating a known visual aid available on the market.

A further objective of the invention is to minimize tampering with the visual aid after installation of a protective cover.

Yet another objective of the invention is to provide a means for easy removal of the protective cap from the fastening members without destruction of the cap.

Another objective of the invention is to provide a cover which is retained on top of the fastening members with the assistance of suction force along with a friction fit.

Further benefits of the invention will be apparent to one skilled in the art from the detailed review of the following summary of the invention and the more detailed description of the preferred embodiments illustrated herein.

### SUMMARY OF THE INVENTION

A protective cover is defined by a body having a top and bottom, with internal and external surfaces. The internal surface of the cover snugly fits the fastening member and the external surface includes a flange assembly to accommodate a visual aid. The protective cover protects the fastening member from the elements and restricts the movement of the visual aid. Preferably the protective cover is made in one piece from a plastic material preferably polyethylene, more preferably shrunk fit polyethylene.

According to one aspect of the invention there is provided a protective cover for a fastener, said protective cover comprising a body having a top and a bottom, an internal hollow extending from top to bottom and an external surface; the external surface comprises flanges adapted to receive a visual aid for indicating the security status of the fastener, said flanges including a gripping collar and a top collar having a plurality of vertical ribs extending there-between to restrict the movement of the visual aid, wherein the protective cover receives the visual aid and secures it with the flanges.

According to another aspect of the invention there is provided a protective cover for a wheel fastening member, said protective cover comprising a body having a top and a bottom, an internal hollow extending from top to bottom and surrounded by an adjacent internal surface and an external surface; the internal surface of the protective cover snugly fitting over the fastening member in use and the external surface comprising flanges to receive a visual aid for indicating the security status of the fastening member, said flanges including a gripping collar and a top collar having a plurality of vertical ribs extending there-between to restrict the movement of the visual aid, wherein the protective cover protects the fastening member from corrosion and secures the visual aid therewith.

In one embodiment the protective cover, the gripping collar of the flanges extends substantially perpendicular to the body of the protective cover and serves as a grip for the placement and removal of the cover from the fastener or fastening member.

In another embodiment the protective cover and preferably the external surface further comprises a rim at the bottom to improve engagement with the fastening member.

In yet another embodiment of the protective cover the number of vertical ribs extending between said flanges is a multiple of six, for example 6, 12, 18, 24, 30, 36, 42, 48.

Preferably the top collar further comprises a top portion and a flat bottom portion to accommodate installation of the visual aid and along with the gripping flange to prevent its removal.

In yet another embodiment of the protective cover the hollow internal surface further comprises a chamber to accommodate the fastening member, to engage the fastening member by means of a friction of it.

The protective cover is preferably made in one piece from a plastic material and preferably said plastic is selected from polyethylene, LDPE, HDPE or shrunk fit polyethylene.

According to another aspect of the invention there is provided a corrosion resistant nut cover for a wheel retaining hub-piloted nut fastened to a wheel end stud, said cover adapted to receive a visual aid indicating loosening of the nut, said cover comprising a cylindrical tapered body having a top and a bottom, a hollow surounded by an internal surface and an external surface extending from top to bottom, the internal surface of the protective cover adapted to accommodate the stud and to snugly friction fit the hub-piloted nut, the external surface comprising a rim at the bottom of the cover, said rim providing ease of fit of the cover and nut, and a flange assembly to receive the visual aid, said flange assembly comprising a gripping collar and a top collar having a plurality of vertical ribs extending between the collars to restrict the movement of the visual aid; wherein the cover protects the nut from corrosion and restricts the movement of the visual aid.

Prefereably the gripping collar of the flange assembly serves as a grip for the placement and removal of the cover from the hub-piloted nut.

Preferably the number of vertical ribs extending between said flanges is a multiple of six, for example 6, 12, 18, 24, 30, 36, 42, 48.

Preferably the top collar is unidirectional, having a curved top portion and a horizontal flat bottom portion to ease the installation of the visual aid and to prevent its removal.

In another embodiment of the protective cover the internal surface of the cover further comprises a smaller dimension than the corresponding hub-piloted nut to ensure that the cover is engaged with the nut by suction force created when placing the cover over said nut in addition to a friction force.

In another embodiment the cover is preferably made in one piece from a material selected from PE, LDPE, HDPE or shrunk fit polyethylene.

### BRIEF DESCRIPTION OF THE DRAWINGS

FIG. 1 is a perspective elevated view of the cover.

FIG. 2 is a front view of the cover.

FIG. 3 is a bottom view to the inside of the cover.

FIG. 4 is a top view of the cover.

FIG. 5 is a top view of a visual aid (prior art).

FIG. 6 is a top view of the visual aid attached to the cover of the invention.

FIG. 7 is a cross sectional side view through line A-A of FIG. 6.

FIG. 8 is a cross sectional side view of a variant of the cover through line A-A of FIG. 6.

### DETAILED DESCRIPTION OF THE INVENTION

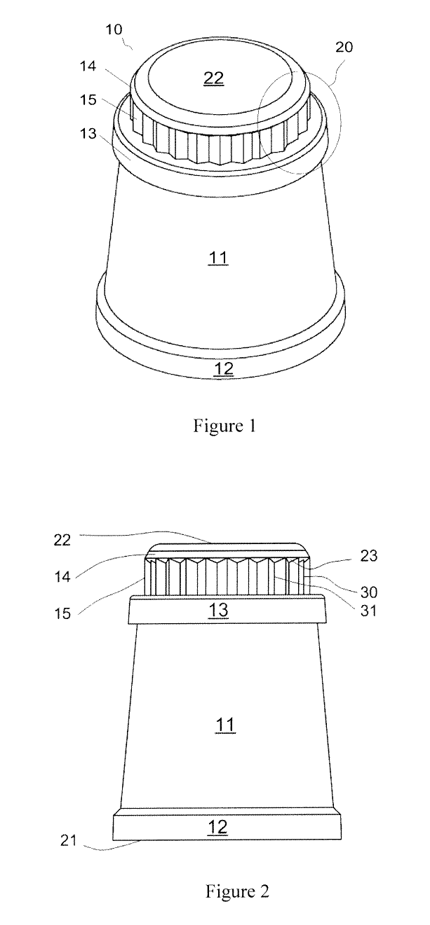

The protective cover 10 for fasteners 50 illustrated in FIG. 1 comprises a body 11 with a bottom 21, a top 22 and a flange joint 20. The flange joint 20 has a lower collar/grip 13, a top collar/brim 14 and a grooved section/rib portion 15. The flange joint is constructed to receive a visual aid member 40 such as a flag or a nut security indicator.

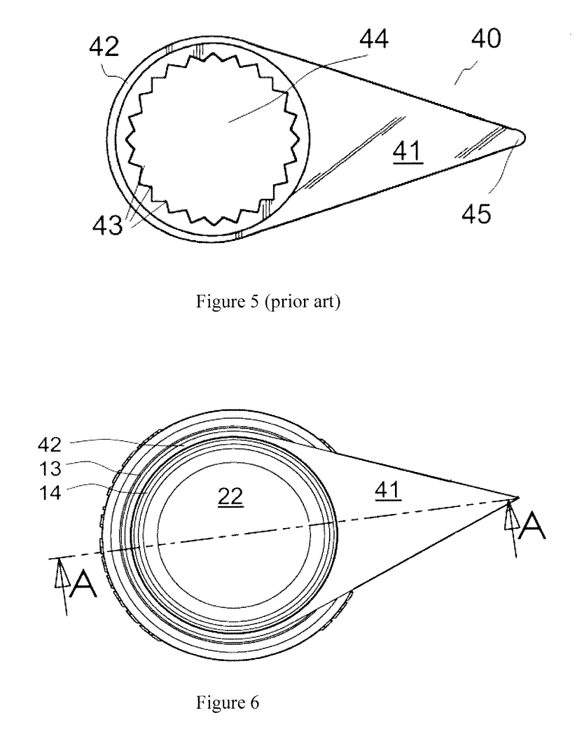

As best seen in FIG. 5 the visual aid 40 includes a ring with attached flag 41 and the ring also has a plurality of teeth 43 to engage the ribs between the flanges 13 and 14. The cover may be manufactured to accept readily available visual aids or specifically manufactured visual aids. Examples of readily available visual aids includes “Wheel-Check” and “Checkpoint®” attachments among others. These visual aids assist in the determination of the correct position of the fastening member.

The generic visual aid 40 illustrated in FIG. 5 has a pointer portion 41 and a ring portion 42 with alternating voids 44 and teeth 43. The tip 45 of the pointer portion may be of any desired form, such as an arrow, pin point, triangle, rounded, diamond shaped or the like.

The fasteners may include any members known in the art, including nuts, nuts with extending stud, a hub-piloted wheel nut and so on. The preferred fasteners includes a wheel fastening members such as nuts and bolts for retaining a wheel of a car or truck in place.

The body 11 of the protective cover is an elongated cylindrical shape of straight or tapered sides with a hollow interior 19.

At the tapered bottom of the protective cover there is an additional flange 12 provided which improves the rigidity of the protective cover and provide better gripping of the fastener.

The lower collar 13 is disposed near the top portion of the protective cover adjacent the flange joint 10. As best seen in FIG. 2, the lower collar 13 creates a lip which prevents the visual aid from slipping down the body, and provides support for the visual aid.

Further the lower collar 13 acts as a grip for the removal of the protective cover from the fastener. The cover may be removed for tightening, lubricating or other maintenance operation of the fasteners. The use of the grip makes the removal of the cover an easier task and also permits possible reuse of the cover. Therefore, the collar 13 acts both as a support for the visual aid and as a grip for the removal of the protective cover from the fasteners.

Directly, above the collar 13 is a section 15 including alternating grooves and ridges. Section 15 is adapted to receive a visual aid and retains it in an immobilized position restricting its movement with respect to the protective cover. Grooves 31 alternate with ribs 30 in order to receive the teeth 43 of the visual aid. Alternatively, the grooved section may include other patterns to receive compatable visual aids. Other patterns may include curves, indents, balls or the like. However, the vertical ribs are preferred.

The number of grooves and ribs circling the flange assembly is a multiple of six. A multiple of six means any number which can be divided by six such as 6, 12, 18, 24, 30, 30, 36, 42, 48 and so on, in that the current visual aids are installed on hexagonal bolts with six sides. In order to receive visual aids 40, the number of the alternating grooves and ridges 31 must correspond to the number of teeth 43 of the visual aid. In a preferred embodiment, the number of grooves is 24. However, for a custom made visual aid the number of grooves can be accomodated accordingly.

The shape of the grooves is to be adapted to receive the corresponding shape of the teeth of the visual aid. Therefore, the general triangular shape of the ribs 30 and grooves 31 illustrated in FIGS. 1 and 2 are preferred but the teeth may be of any suitable compatable design.

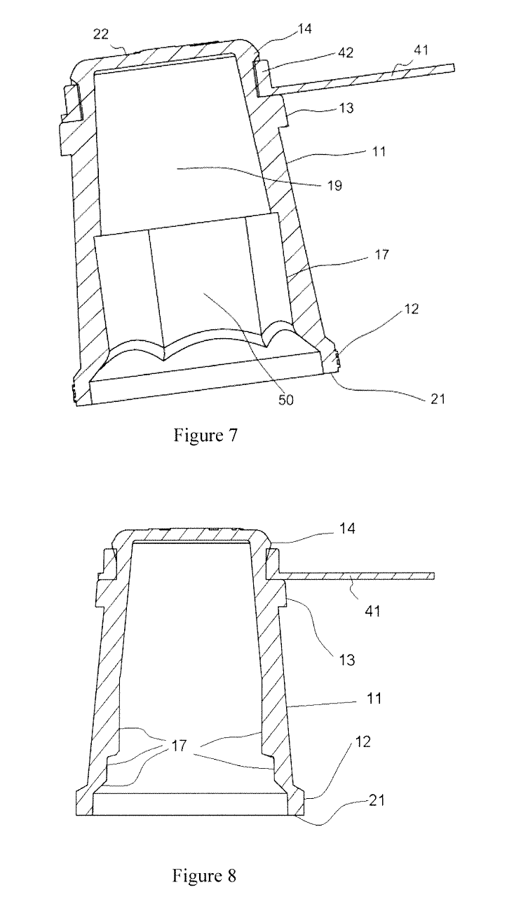

Further, the flange joint 20 includes a cap 14 above the grooved section. Cap 14 is substantially parallel to the collar 13 and extends radially from the top 22. The cap restricts any vertical displacement of the visual aid from the grooved section 15, since the grooves of the grooved sections are effectively covered by the cap. Therefore, after the installation of the visual aid, teeth 43 of the visual aid snap into the grooves under the cap and remains there as illustrated in FIG. 7. The rounded top section 22 allows easy insertion of the visual aid with the cover and the flat bottom part of the cap 14 restricts the removal of the visual aid.

Any displacement of the visual aid is restricted by the collar 13 at the bottom of the flange assembly and by the cap 14 at the top of the flange joint 20, which prevents both the accidental removal of the visual aid from the protective cover and tampering with the visual aid.

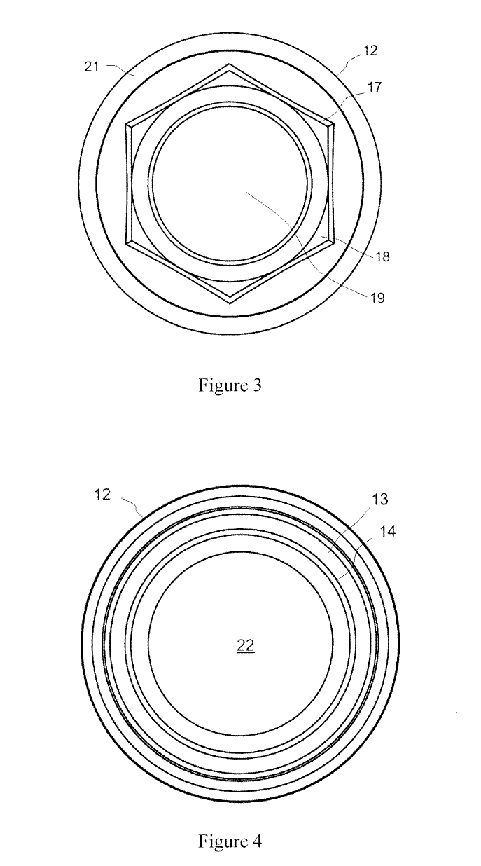

As shown in FIG. 3, the interior portion of the protective cover includes a hollow 19 to accept the stud of the bolt and the fitting member 17 to engage the sides of the fasteners. The fitting member 17 is hexagonal and fits the dimensions of the nut portion of a hub-piloted wheel nut assembly, best shown in FIG. 7. The fitting member provides a full physical contact with the fasteners. The fitting member can be adjusted to receive fasteners of various sizes and forms as known in the art. For example the fitting member 17 can be rectangular or star-shaped. One of the variants is shown in FIG. 8.

The protective cover is manufactured from a plastic material, preferably soft plastic material. More preferably the protective cover is manufactured as a single piece unit from polyethylene such as LDPE (low density polyethylene). Preferably the polyethylene material is shrunk fit to cover 100% of the mating surfaces of the fasteners.

The engagement between the fitting member and the sides of the fasteners should be air tight. Therefore upon installation suction is created between the fasteners and the protective cover. This is achieved by forcing the air from the hollow of the protective cover. The suction is in addition to the friction fit that holds the protective cover on top of the fastener to protect it from the elements, such as moisture, dust, dirt, chemicals and other means which may deteriorate the fasteners.

The internal dimension of portion 18 is smaller than the dimension of the corresponding fastener. In this way the protective cover has to be forced fit on top of the fastener resulting in yet improved attachment and air tightness.

The flange assembly is preferably adapted to receive visual aids currently available on the market, such as those of “Wheel check®” and “Checkpoint®”. However the flange assembly may be modified to accept other forms and designs of visual aids without differing from the spirit of the invention. For example, the outer diameter of the grooves 15 may be larger or smaller then the diameter of the fasteners receiving the protective cover.

The visual aid is installed after the fastening member is in the correct position and covered by the protective cover. The visual aid is installed in the flange assembly and pointed toward a predetermined reference point or toward an adjacent visual aid. When the fastening member moves undesirably the visual aid would also move along with the protective cover and point in a different direction. This undesired movement can be readily determined by an operator during a scheduled visual check of all of the wheels. In that case, when the visual aid points towards a position different than normal, the operator would assume that the fastener has become loose. The operator would then remove the protective cover by accessing the grip, tighten the fastener and place the protective cover back, with the visual aid pointing toward the normal position once again.

As many variations can be made to the embodiments of the invention without departing from the scope of the invention; it is intended that all matter contained herein be interpreted as illustrative of the invention and not in a limiting sense.

The embodiments of the invention in which an exclusive property or privilege is claimed are as follows:

1. A protective cover for a fastener, said protective cover comprising a body having a top and a bottom, an internal hollow extending from top to bottom and an external surface; the external surface comprises flanges adapted to receive a visual aid for indicating the security status of the fastener, said flanges including a gripping collar and a top collar having a plurality of vertical ribs extending therebetween to restrict the movement of the visual aid, wherein the protective cover receives the visual aid and secures it with the flanges.

2. A protective cover for a wheel fastening member, said protective cover comprising a body having a top and a bottom, an internal hollow extending from top to bottom and surrounded by an adjacent internal surface and an external surface; the internal surface of the protective cover snugly fitting over the fastening member in use and the external surface comprising flanges to receive a visual aid for indicating the security status of the fastening member, said flanges including a gripping collar and a top collar having a plurality of vertical ribs extending therebetween to restrict the movement of the visual aid, wherein the protective cover protects the fastening member from corrosion and secures the visual aid therewith.

3. A corrosion resistant nut cover for a wheel retaining hub-piloted nut fastened to a wheel end stud, said cover adapted to receive a visual aid indicating loosening of the nut, said cover comprising a cylindrical tapered body having a top and a bottom, a hollow surrounded by an internal surface and an external surface extending from top to bottom, the internal surface of the protective cover adapted to accommodate the stud and to snugly friction fit the hub-piloted nut, the external surface comprising a rim at the bottom of the cover, said rim providing ease of fit of the cover and nut, and a flange assembly to receive the visual aid, said flange assembly comprising a gripping collar and a top collar having a plurality of vertical ribs extending there-between the collars to restrict the movement of the visual aid; wherein the cover protects the nut from corrosion and restricts the movement of the visual aid.

4. The protective cover of claim 1, 2 or 3 wherein the gripping collar of the flanges extends substantially perpendicular to the body of the protective cover and serves as a grip for the placement and removal of the cover from the fastener or fastening member.

5. The protective cover of claim 1, 2 or 3 wherein the external surface further comprises a rim at the bottom to improve engagement with the fastening member.

6. The protective cover of claim 1, 2 or 3 wherein the number of vertical ribs extending between said flanges is a multiple of six, for example 6, 12, 18, 24, 30, 36, 42, 48.

7. The protective cover of claim 1, 2 or 3 wherein the top collar further comprises a top portion and a flat bottom portion to accommodate installation of the visual aid and along with the gripping flange to prevent its removal.

8. The protective cover of claim 1, 2 or 3 wherein the hollow internal surface further comprises a chamber to accommodate the fastening member, to engage the fastening member by means of a friction fit.

9. The protective cover of claim 1, 2 or 3 made in one piece from a plastic material.

10. The protective cover of claim 9 wherein said plastic is selected from polyethylene, LDPE, HDPE or shrunk fit polyethylene.

11. The flange assembly of claim 1, 2 or 3 wherein the top collar is unidirectional, having a curved top portion and a horizontal flat bottom portion to ease the installation of the visual aid and to prevent its removal.

12. The protective cover of claim 1, 2 or 3 wherein the internal surface of the cover further comprises a smaller dimension than the corresponding hub-piloted nut to ensure that the cover is engaged with the nut by suction force created when placing the cover over said nut in addition to a friction force.
